(19) United States
(12) Patent Application Publication
(10) Pub. No.: US 2011/0034218 A1
(43) Pub. Date: Feb. 10, 2011

(54) In-Ear Earphone

(75) Inventors: Po-Hsun Sung, Taichung (TW); Yu-Chang Y. Fan, Taichung (TW); Chien-Chang Yang, Taichung (TW)

Correspondence Address: LanWay IPR Services, P.O. Box 220746, Chantilly, VA, 20153, US

(73) Assignee: Merry Electronics Co., Ltd.

(21) Appl. No.: 12/641,304

(22) Filed: Dec. 17, 2009

(30) Foreign Application Priority Data
Aug. 6, 2009 (TW) 098126640

(51) Int. Cl. H04M 1/00

(52) U.S. Cl. 455/569.1

(57) ABSTRACT

An in-ear earphone includes a housing, a transducer, a sound tube and an earplug. The transducer is disposed in the housing. The sound tube is extended outward from the housing. The sound tube has a first channel connected with the housing for receiving the acoustic wave generated by the transducer, and a second channel connected with first channel and having a cross-section area different from the first channel. The earplug is disposed on the sound tube to be inserted into the ear channel of a user so as to reduce the frequency response of the acoustic wave which is delivered to the ear cannel of the user.

### BACKGROUND

1. Field of the Invention

The present invention generally relates to earphones, and more particularly to an in-ear earphone that can improve high frequency performance by a sound tube with different cross section areas.

2. Description of Prior Art

Nowadays, earphones are usually used for personal listening when being applied to MP3 media players, mobile phones, personal digital assistants (PDAs), notebook computers, and so on. Thus, the earphone becomes one of the necessary elements of electronic device. However, though an earphone can be connected to different electronic devices, the main requirement for the earphone is a good acoustic performance for hearing of a user.

Referring to FIG. 1, it shows a traditional in-ear earphone. An earphone 1 includes a housing 2, an electro-acoustic transducer 3 disposed in the housing 2, a sound tube 4 crabwise disposed at a front end of the housing 2, and an earplug 5 disposed at a front end of the sound tube 4. The electro-acoustic transducer 3 in the housing 2 usually is a loudspeaker. When using, the sound tube 4 and the earplug 5 are inserted into the external auditory canal of a user. The electro-acoustic transducer 3 generates a sound which is delivered to the external auditory canal of the user through the sound tube 4 for providing a sound data to the earphone 1 of the user.

However, except for the primary design of the electro-acoustic transducer 3, the path of acoustic wave provided by the housing 2 and the sound tube 4 is also an important influence element for the quality of the frequency response. In addition, the diameter of the sound tube 4 is usually a single size. When an acoustic wave is generated from a surface of the electro-acoustic transducer 3, the acoustic wave is delivered to the external auditory canal of the user through the sound tube 4. When the acoustic wave is delivered, an effect of an acoustic low pass filter is appeared due to the sound field of the straight tube. Thus, the design of the sound tube 4 of the earphone 1 may cause that sensitivity of the sound in high frequency is decreased due to its characteristic of a sensitivity is reduced rapidly in high frequency area. As a result, user hears less high frequency sound and receives a worse sound quality. The associative perception of sound of the earphone is affected. Further, all of the in-ear earphones in the market use the straight tube and have the above disadvantages. Thus, how to solve the problems of the traditional earphone is important for the manufacturers.

### BRIEF SUMMARY

One objective of the present invention is to provide an earphone, especially to provide an earphone with a sound tube having different cross section area in different segments, so as to avoid the acoustic curve of the earphone from rapidly reduction in high frequency area and have a better acoustic performance of the earphone.

In one embodiment of the present invention, an in-ear earphone includes a housing, a transducer, a sound tube, and an earplug. The electro-acoustic transducer is disposed in the housing. The sound tube is extended outward from the housing. The sound tube has a first channel connected with the housing for receiving the acoustic wave generated by the transducer, and a second channel connected with the first channel. Wherein, a cross-section area of the first channel and a cross-section area of the second channel are different for forming different acoustic filter characteristics to reduce specific frequency or avoid specific frequency being reduced and deliver the acoustic wave outward the earphone. The earplug is disposed on the sound tube for inserting into an external auditory canal of a user.

Thus, when the in-ear earphone delivers a sound, the acoustic wave is delivered into the second channel through the first channel. The cross section area changes urgently so as to produce a character different from the single size tube. A similar periodic band-pass filter is formed to reduce a specific frequency or avoid specific frequency area being reduced. Therefore, the acoustic wave can be avoided from reducing rapidly in high frequency area and the earphone has a better acoustic curve for promoting the sound quality and clarity.

In another embodiment, the in-ear earphone has an acoustic damper disposed in the second channel. Due to the size of the second channel, the acoustic wave in a needless frequency area can be reduced. And the acoustic damper damps the acoustic wave passing through the second channel for adjusting the sensitivity curve of the earphone. The earphone can have a better acoustic performance.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic cross section view of an in-ear earphone according to the prior art.

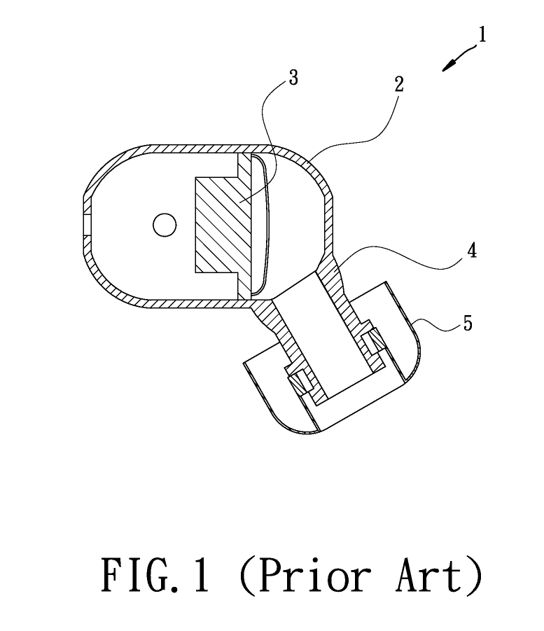

FIG. 2 is a schematic cross section view of an in-ear earphone in accordance with a preferred embodiment of the present invention.

FIG. 3 is a schematic view of a delivery path of an acoustic wave in the in-ear earphone depicted in FIG. 2.

FIG. 4 is a contrast graph of acoustic curves of the in-ear earphones between the present invention and the prior art.

FIG. 5 is a schematic cross section view of an in-ear earphone in accordance with another preferred embodiment of the present invention.

### DETAILED DESCRIPTION

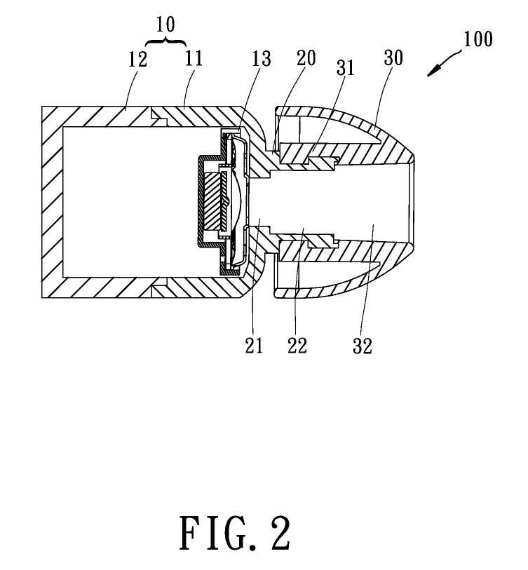

Referring to FIG. 2, it shows a schematic cross section view of an in-ear earphone 100 according to the present invention. The earphone 100 of the present invention includes a housing 10 and a sound tube 20. An earplug 30 is disposed at a proximal end of the sound tube 20. The earplug 30 is provided for inserting the earphone 10 into user's external auditory canal to deliver a sound.

The housing 10 includes a front housing 11 and a rear housing 12. The front housing 11 and the rear housing 12 are conjoined relatively to form the housing 10. An electro-acoustic transducer 13 is disposed in the front housing 11. In the preferred embodiment, the electro-acoustic transducer 13 is a moving-coil speaker. Of course, the electro-acoustic transducer 13 also can be a balanced armature type of speaker or the other types of speakers.

The sound tube 20 is extended outward from the front surface of the front housing 11. The direction of a sound of the sound tube 20 is coaxial with the housing 10 and extended outward from the housing 10. The sound tube 20 has a first channel 21 disposed at one end near the electro-acoustic transducer 13. The first channel 21 is connected with the front housing 11. A second channel 22 is disposed at the other end of the sound tube 20 away from the electro-acoustic transducer 13 and connected with the first channel 21. In the preferred embodiment, the cross section area and the cubage of the second channel 22 are both larger than those of the first channel 21. Of course, it can be that, the cross section area of the second channel 22 is larger than the cross section area of the first channel 21, but the cubage of the second channel 22 is smaller than the cubage of the first channel 21; and or, the cross section area of the second channel 22 is smaller than the cross section area of the first channel 21, but the cubage of the second channel 22 is larger than the cubage of the first channel 21.

The earplug 30 has an assembly portion 31 coiled around the sound tube 20 for holding the sound tube 20. The earplug 30 is made of an elastic material, such as rubber or polyurethane. When the earphone 10 is inserted into the external auditory canal of a user, the external auditory canal of the user can be easily sealed by the earplug 30 due to an elastic deformation of the earplug 30. In addition, the earplug 30 has an airflow channel 32 connected with the second channel 22 for delivering sound airflow to an outward of the earphone 100.

When the earphone 100 is inserted in the external auditory canal of the user, the electro-acoustic transducer 13 generates a sound. The acoustic wave of the sound delivered from a sound surface of the electro-acoustic transducer 13 towards the first channel 21 and through the second channel 22 and airflow channel 32 in order so that the acoustic wave is delivered to the external auditory canal of the user for providing sound data.

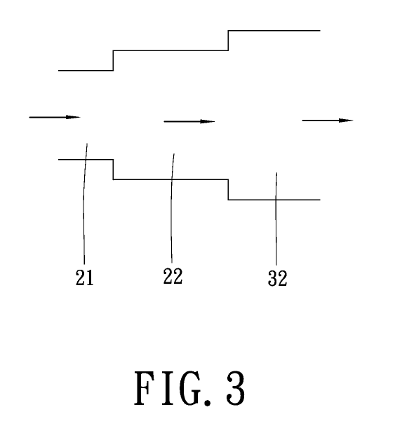

Referring to FIG. 3, it shows a schematic view of a delivery path of an acoustic wave in the in-ear earphone depicted in FIG. 2. When the acoustic wave is delivered from the first channel 21 to the second channel 22, the cross section area is changed from small to large. Due to the cross section area changes urgently, a difference between the acoustic wave impedances in the first channel 21 and the second channel 22 is generated to form an impedance mismatch. Thus, the acoustic wave is reduced in some frequency area which usually is intermediate frequency area. When the acoustic wave is reduced in some frequency area, the acoustic curve in some other frequency can be maintained. The sound tube 20 having different cross section areas of the present invention is similar to a periodic band-pass filter, and the certain frequency can be reduced effectively and the certain frequency range can be avoided to reduce. Compared with the prior earphone that having a sound tube with a single size, the earphone 100 of the present invention has a better acoustic performance.

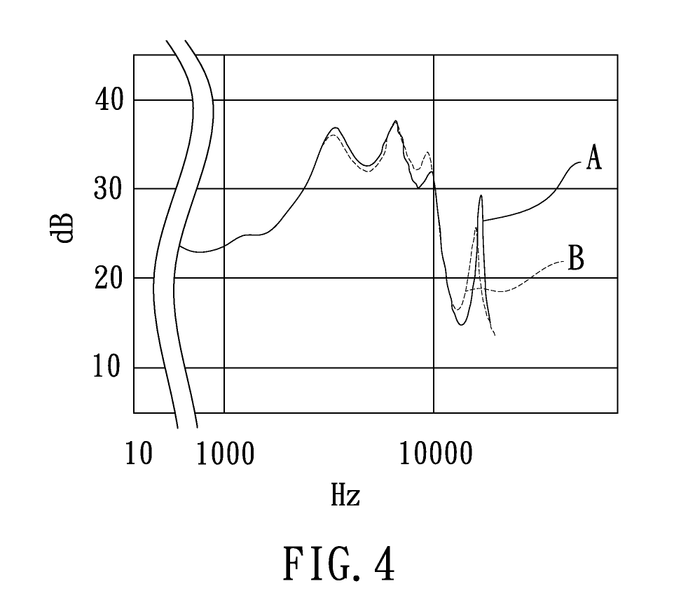

Referring to FIG. 4, it shows a contrast graph of acoustic curves of the in-ear earphones between the present invention and the prior art. A curve B is a response curve of the earphone of the present invention, and a curve A is a response curve of the earphone of the prior art. By comparing with the curve B and the curve A, the curve B is reduced in the intermediate frequency area but it is not reduced rapidly in the high frequency area. Thus, the high frequency curve of the earphone can be adjusted to cause the earphone 100 has a better sensitivity. The response curve with low reduction can cause the earphone 100 has a better acoustic quality.

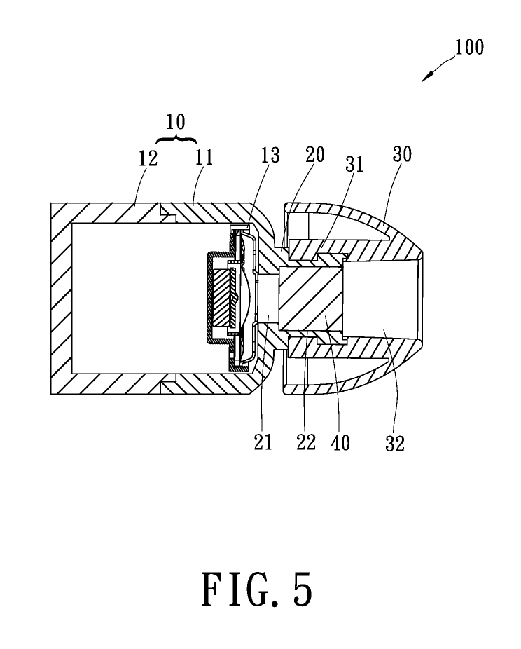

Referring to FIG. 5, it shows a schematic cross section view of an in-ear earphone in accordance with another exemplary embodiment. The earphone 100 has an acoustic damper 40 disposed in the sound tube 20. In the present invention, the acoustic damper 40 is disposed at the second channel 22. The acoustic damper 40 is made of a porous elastic material, such as polyurethane. Due to the acoustic damper 40 is breathable, when the acoustic wave passes, the acoustic wave of the certain frequency can be reduced by the acoustic damper 40. Thus, the sensitivity curve of the earphone 100 can be adjusted and the earphone 100 can have a better acoustic performance.

As mentioned above, the in-ear earphone of the present invention has a first channel and a second channel disposed in the sound tube. The first and the second channels are connected with each other. The cross section area of the second channel is larger than the cross section area of the first channel. Thus, when the in-ear earphone delivers a sound, the acoustic wave is delivered into the second channel through the first channel. The cross section area changes urgently so as to form an impedance mismatch. Thus, the acoustic wave is reduced in the intermediate frequency area and not reduced rapidly in the high frequency area. Therefore, the earphone 100 of the present invention has a better acoustic curve, and the sound quality and clarity can be improved.

In addition, the earphone in present invention has an acoustic damper disposed in the second channel to damp the acoustic wave passing through the second channel, so as to adjust the sensitivity curve of the earphone to cause a better acoustic performance of the earphone.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An in-ear earphone, comprising:
a housing;
an electro-acoustic transducer disposed in the housing;
a sound tube extended outward from the housing, the sound tube having a first channel connected with the housing for receiving an acoustic wave generated by the transducer and a second channel connected with the first channel; and
an earplug disposed on the sound tube for being inserted into an external auditory canal of a user;
wherein, a cross-section area of the second channel is different from a cross-section area of the first channel for reducing the acoustic wave generated by the electro-acoustic transducer and delivering the acoustic wave outward.

2. The in-ear earphone as claimed in claim 1, wherein the cross-section area of the second channel is larger than the cross-section area of the first channel.

3. The in-ear earphone as claimed in claim 1, wherein a cubage of the second channel is larger than a cubage of the first channel.

4. The in-ear earphone as claimed in claim 1, wherein the housing is composed of a front housing and a rear housing, and the electro-acoustic transducer is disposed at the front housing.

5. The in-ear earphone as claimed in claim 1, wherein the sound tube has an acoustic damper disposed therein.

6. The in-ear earphone as claimed in claim 5, wherein the acoustic damper is disposed in the second channel.

7. The in-ear earphone as claimed in claim 5, wherein the acoustic damper is made of porous elastic material.

8. The in-ear earphone as claimed in claim 5, wherein the acoustic damper is made of polyurethane.
